(19) United States
(12) Patent Application Publication
(10) Pub. No.: US 2017/0074143 A1
(43) Pub. Date: Mar. 16, 2017

(54) EXHAUST GAS PURIFICATION APPARATUS FOR INTERNAL COMBUSTION ENGINE

(71) Applicant: TOYOTA JIDOSHA KABUSHIKI KAISHA, Toyota-shi, Aichi (JP)

(72) Inventor: Takeru SHIRASAWA, Susono-shi (JP)

(73) Assignee: TOYOTA JIDOSHA KABUSHIKI KAISHA, Toyota-shi, Aichi (JP)

(21) Appl. No.: 15/122,990

(22) PCT Filed: Feb. 25, 2015
(86) PCT No.: PCT/JP2015/000969

§ 371 Date: Sep. 1, 2016

(30) Foreign Application Priority Data
Mar. 7, 2014 (JP) 2014-045171

(51) Int. Cl. F01N 9/00; F02D 41/02; F02D 41/00; B01D 53/94; F01N 3/28; F01N 3/20; B01D 46/00; F01N 3/023; F01N 3/035

(52) U.S. Cl. CPC F01N 9/002; F01N 3/023; F02D 41/0235; F02D 41/0055; F01N 3/035; F01N 3/2892; F01N 3/2066; B01D 46/006; B01D 53/9431; B01D 46/0027; F01N 2240/20; F01N 2240/25; F01N 2250/02; F01N 2610/02; F01N 2900/0418; B01D 2279/30

(57) ABSTRACT

In an exhaust gas purification apparatus for an internal combustion engine in which a filter for trapping PM, and a deflector for deflecting exhaust gas flowing into the filter, are arranged in an exhaust passage, in cases where a state continues in which the flow rate of the exhaust gas does not change relatively, regeneration processing of the filter is carried out so that a local excessive temperature rise resulting from non-uniform deposition of PM does not occur. When an integrated period of time, which is obtained by integrating a period of time in which an amount of change per unit time of a flow rate of the exhaust gas deflected by the deflector is equal to or less than a predetermined threshold amount of change, becomes equal to or more than a predetermined threshold period of time, during the time the regeneration processing is not carried out, the controller performing the regeneration processing of the filter carries out the regeneration processing before an estimated amount of PM deposited in the filter becomes equal to or more than a predetermined threshold amount of deposition.

### CROSS-REFERENCE TO RELATED APPLICATIONS

This application is a national phase application of International Application No. PCT/JP2015/000969, filed Feb. 25, 2015, and claims the priority of Japanese Application No. 2014-045171, filed Mar. 7, 2014, the content of both of which is incorporated herein by reference.

### TECHNICAL FIELD

The present invention relates to an exhaust gas purification apparatus for an internal combustion engine which is provided with a filter for trapping particulate matter in exhaust gas.

### BACKGROUND ART

In the past, there has been known an exhaust gas purification apparatus in which a filter for trapping particulate matter (PM) in exhaust gas is arranged in an exhaust passage of an internal combustion engine. In this kind of exhaust gas purification apparatus, when the amount of deposition of PM increases, the function of the filter may drop, so that regeneration processing to remove the deposited PM by means of oxidation is carried out. However, in cases where the amount of the deposited PM is large to an excessive extent, there is a fear that the filter may arrive at an excessive temperature rise (i.e., an excessively high temperature) at the time of execution of the regeneration processing. For that reason, the regeneration processing is carried out, before an amount of PM deposits in which the excessive temperature rise of the filter may occur.

However, it is known that the distribution of the deposited PM in the filter changes according to the flow rate of the exhaust gas flowing into the filter. For that reason, depending on the flow rate of the exhaust gas, there may occur a phenomenon called non-uniform deposition in which PM deposits in a specific region in the filter non-uniformly or unevenly. When the regeneration processing is carried out at the time of the occurrence of the non-uniform deposition, the temperature of the region in which the PM deposits unevenly in the filter can become locally high. Therefore, depending on the degree of the non-uniform deposition, even though the amount of the PM deposited in the entire filter is not excessive, the temperature in the region in which the non-uniform deposition has occurred is caused to excessively rise locally during the execution of the regeneration processing, thus giving rise to a fear that the region concerned may be damaged.

Here, in a first patent literature, there is disclosed a technology in which in an exhaust gas purification apparatus for an internal combustion engine in which regeneration processing is carried out when an amount of PM exceeding a permissible amount deposits in a filter, a non-uniform deposition index indicating the degree of non-uniform deposition of PM per unit time is calculated based on the flow rate of exhaust gas and the amount of PM discharge, and the permissible amount is subtracted according to a value which is obtained by integrating this non-uniform deposition index after the execution of the last regeneration processing. Here, in the first patent literature, it is disclosed that the larger the flow rate of the exhaust gas, the larger becomes the non-uniform deposition index. In other words, in the exhaust gas purification apparatus disclosed in the first patent literature, the larger the flow rate of the exhaust gas, the more the permissible amount of the PM deposition is subtracted, and hence, as a result, it can be said that the regeneration processing of the filter is carried out at an earlier stage.

### CITATION LIST

### Patent Literature

[PTL 1] Japanese patent laid-open publication No. 2008-128063

[PTL 2] Japanese patent laid-open publication No. 2010-31853

[PTL 3] Japanese patent laid-open publication No. 2009-2276

[PTL 4] Japanese patent laid-open publication No. 2007-162635

[PTL 5] Japanese patent No. 4466158

[PTL 6] Japanese patent laid-open publication No. 2009-228494

[PTL 7] Japanese patent laid-open publication No. 2008-180189

[PTL 8] Japanese patent laid-open publication No. 2012-87649

[PTL 9] Japanese patent laid-open publication No. 2010-144514

[PTL 10] Japanese patent laid-open publication No. 2004-190667

### SUMMARY OF INVENTION

### Technical Problem

However, in an exhaust gas purification apparatus for an internal combustion engine mounted on a motor vehicle, etc., a curved portion may be formed in an exhaust passage at the upstream side of a filter. In addition, in recent years, there has been developed a filter in which a selective catalytic reduction catalyst (SCR catalyst) for selectively reducing nitrogen oxides (NOx) in exhaust gas by using a reducing agent is carried or supported by a substrate, but in an exhaust gas purification apparatus provided with this kind of filter, a dispersion plate for deflecting the exhaust gas may be arranged at the upstream side of the filter, in order to disperse the reducing agent to be added from a reducing agent addition device to a sufficient extent in the exhaust gas flowing into the filter. Here, it has become clear that in these exhaust gas purification apparatuses, the exhaust gas flowing into the filter is deflected by the curved portion or the dispersion plate, so that the exhaust gas can flow into a specific region of the filter in an intensive manner. For that reason, it has become clear that in cases where a state continues in which the flow rate of the exhaust gas does not change relatively, non-uniform deposition of PM may occur in the region into which the exhaust gas flows intensively, without regard to the flow rate of the exhaust gas.

Here, in the exhaust gas purification apparatus disclosed by the above-mentioned first patent literature, when the non-uniform deposition index is calculated, no consideration is given to a change in the flow rate of the exhaust gas. Accordingly, in cases where the state continues in which the flow rate of the exhaust gas does not change relatively, there is a fear that the non-uniform deposition of PM may be overlooked, without taking any particular measure for detecting the non-uniform deposition. As a result, if the regeneration processing of the filter is carried out when the amount of deposition of PM in the entire filter has reached the permissible amount, a local excessive temperature rise will occur in a region in which the non-uniform PM deposition has progressed, thus resulting in a fear that the region may be damaged.

The present invention has been made in view of such actual circumstances as referred to above, and has for its object to provide an exhaust gas purification apparatus for an internal combustion engine which is provided with a filter for trapping particulate matter and a deflection unit, such as a curved portion, a dispersion plate, etc., for deflecting exhaust gas flowing into the filter, and which in cases where a state continues in which the flow rate of the exhaust gas does not change relatively, regeneration processing of the filter can be carried out so that a local excessive temperature rise resulting from non-uniform deposition of PM does not occur.

### Solution to Problem

In order to solve the above-mentioned problems, an exhaust gas purification apparatus for an internal combustion engine according to the present invention is provided with:

a filter that is arranged in an exhaust passage of the internal combustion engine for trapping particulate matter in exhaust gas;

a deflector that is arranged at the upstream side of said filter in said exhaust passage and configured to deflect exhaust gas flowing into said filter; and

a controller configured to estimate an amount of deposition of particulate matter deposited in said filter, and carry out regeneration processing to oxidize the particulate matter deposited in said filter when the estimated amount of deposition estimated by said controller is equal to or more than a predetermined threshold amount of deposition;

wherein when an integrated period of time, which is obtained by integrating a period of time in which an amount of change per unit time of a flow rate of the exhaust gas deflected by said deflector is equal to or less than a predetermined threshold amount of change, becomes equal to or more than a predetermined threshold period of time, during the time said regeneration processing is not carried out, said controller further configured to carry out said regeneration processing before said estimated amount of deposition becomes equal to or more than said predetermined threshold amount of deposition.

The above-mentioned deflector has a member arranged in the exhaust passage, or a curved portion formed on the exhaust passage, and includes the provision of the member or the curved portion with or without an intention to deflect the exhaust gas flowing into the filter. Here, note that the “deflection” referred to herein means that the exhaust gas flowing through the interior of the exhaust passage has a distribution of its flow speed with a deflection or deviation occurring therein, while maintaining the state to flow from an upstream side to a downstream side as a whole. In addition, the above-mentioned controller estimates the amount of deposition of the PM by integrating an amount of PM deposited in the filter per unit time which is estimated from the number of revolutions per unit time of the internal combustion engine, an engine load, an amount of intake air, etc., for example. Here, note that the predetermined threshold amount of deposition is, in general, an amount which is set to be lower than an amount of deposition of PM in the entire filter at the time when an excessive temperature rise may occur, in order to avoid damage to the filter due to the excessive temperature rise. Then, at the time of starting the regeneration processing, the above-mentioned controller heats the filter up to a temperature at which the deposited PM is oxidized, according to a known method. With this, the deposited PM is removed, so that the PM trapping function of the filter is restored.

However, at the time when the exhaust gas with the deviation occurred in the distribution of flow speed flows into the filter, PM may be trapped intensively in a specific region of the filter in which the exhaust gas of high flow speed passes through. Here, it is considered that the deviation in the flow speed distribution of the exhaust gas deflected by the deflector changes depending on the flow rate of the exhaust gas. Accordingly, it is considered that in cases where the flow rate of the exhaust gas changes to a relatively large extent, the region of the filter in which the exhaust gas of high flow speed passes through also changes continuously, and so, the PM deposited on the filter is mostly dispersed. On the other hand, in cases where the state in which the flow rate of the exhaust gas does not change relatively continues, such as where the internal combustion engine is continuously operated under a constant load, the state in which the exhaust gas of high flow speed locally flows into the specific region in the filter is maintained, and so in that region, localized or non-uniform deposition of PM may occur. Here, it is considered that the degree of the non-uniform deposition thus occurred (e.g., the amount and density of the PM in the region in which the non-uniform deposition has occurred) is dependent on the length of a period of time in which such a state has been maintained. Accordingly, if regeneration processing is carried out when the estimated amount of deposition in the entire filter will have become equal to or more than the threshold amount of deposition in the future due to further deposition of PM in the region in which the non-uniform deposition has occurred, there is a fear that a local excessive temperature rise may occur in that region, depending on the degree of the non-uniform deposition.

Accordingly, in the exhaust gas purification apparatus for an internal combustion engine according to the present invention, when an integrated period of time, which is obtained by integrating the period of time in which the amount of change per unit time of the flow rate of the exhaust gas deflected by the deflector (hereinafter, also referred to simply as “the flow rate of the exhaust gas”) is equal to or less than the predetermined threshold amount of change, becomes equal to or more than the predetermined threshold period of time, during the time the regeneration processing is not carried out, it is judged that when the estimated amount of deposition in the entire filter will become equal to or more than the threshold amount of deposition in the future, there has occurred an amount of non-uniform deposition of PM (hereinafter, also referred to as a “specific non-uniform deposition”) which is assumed to progress (deteriorate) to such a degree as to cause a local excessive temperature rise. As described above, it is considered that non-uniform deposition may occur when the flow rate of the exhaust gas is in a state where it does not change relatively, and hence, the presence or absence of the occurrence of non-uniform deposition can be determined by focusing attention on the amount of change per unit time of the flow rate of the exhaust gas. Here, note that the above-mentioned predetermined threshold amount of change can be set to an upper limit value of the amount of change per unit time of the flow rate of the exhaust gas at the time when it is judged, for example, that non-uniform deposition of PM may occur in the specific region in the filter. This threshold amount of change can be set in advance through experiments or the like, for example, according to the degree of the deflection of the exhaust gas by the deflector. In addition, the above-mentioned predetermined threshold period of time can be set, for example, to a period of time taken for the above-mentioned specific non-uniform deposition to occur, due to the amount of change per unit time of the flow rate of the exhaust gas being equal to or less than the threshold amount of change. This threshold period of time can be set in advance through experiments or the like, for example, according to the heat resistance performance of the filter, the PM trapping ability thereof, etc. Here, note that because the deposited PM remains or continues to exist until regeneration processing is carried out, it is considered that even in cases where the state where the amount of change per unit time of the flow rate of the exhaust gas becomes equal to or less than the predetermined threshold amount of change continues intermittently, the non-uniform deposition of PM may progress. Accordingly, at the time when the integrated period of time, which is obtained by integrating the period of time in which the amount of change per unit time of the flow rate of the exhaust gas is equal to or less than the predetermined threshold amount of change, becomes equal to or more than the predetermined threshold period of time, it may be judged that the specific non-uniform deposition has occurred.

Then, in the exhaust gas purification apparatus for an internal combustion engine according to the present invention, when it is judged, during the time the regeneration processing is not carried out, that the specific non-uniform deposition has occurred, the regeneration processing is carried out before the estimated amount of deposition becomes equal to or larger than the predetermined threshold amount of deposition. With this, it becomes possible to carry out the regeneration processing of the filter, before the non-uniform deposition progresses to such a degree as to cause a local excessive temperature rise. As a result, at the time when the regeneration processing will be carried out in the future, it becomes possible to suppress in advance the occurrence of the local excessive temperature rise resulting from the non-uniform deposition of PM.

In addition, during the time said regeneration processing is not carried out, said controller may increase the estimated amount of deposition estimated by said controller, when said integrated period of time becomes equal to or more than said predetermined threshold period of time, and thereafter, may carry out said regeneration processing when the increased estimated amount of deposition becomes equal to or more than said threshold amount of deposition. Here, the time when the increased estimated amount of deposition becomes equal to or more than said threshold amount of deposition is a time when an amount, which is obtained, for example, by correcting to increase the estimated amount of deposition at the time when said integrated period of time becomes equal to or more than said predetermined threshold period of time, and by further integrating the amount of the PM deposited in the filter after the increase correction accumulated on or added by the amount of deposition thus corrected to be increased, has become equal to or more than said threshold amount of deposition. By carrying out the regeneration processing at such a time, it becomes possible to carry out the regeneration processing of the filter in a more reliable manner, before the non-uniform deposition progresses to such a degree as to cause a local excessive temperature rise. Here, note that during the time said regeneration processing is not carried out, said controller may decrease the threshold amount of deposition, when said integrated period of time becomes equal to or more than said predetermined threshold period of time, and thereafter, may carry out said regeneration processing when said estimated amount of deposition becomes equal to or more than the decreased threshold amount of deposition. By such a configuration, too, there can be obtained the same effect.

Here, in cases where the estimated amount of deposition estimated by the above-mentioned controller is relatively large, it is considered that the amount of discharge of the PM having been discharged from the internal combustion engine before the time of the estimation is relatively large, and hence, the probability that the non-uniform deposition of PM progresses to a more extent is high. Accordingly, during the time said regeneration processing is not carried out, the more the estimated amount of deposition estimated by said controller, the more the above-mentioned controller may decrease said threshold period of time. With this, in cases where the probability that the non-uniform deposition progresses to a more extent is high, it may be judged that the specific non-uniform deposition has occurred at an earlier period of time. Therefore, before the non-uniform deposition progresses to the degree to which the local excessive temperature rise is caused, it becomes possible to carry out the regeneration processing of the filter in a more reliable manner.

However, as stated above, when the amount of change per unit time of the flow rate of the exhaust gas is relatively large, PM will deposit, while being dispersed in the filter, so the non-uniform deposition of PM is relatively difficult to occur. When the amount of PM itself discharged from the internal combustion engine increases, however, the influence, which the change in the flow rate of the exhaust gas has on the dispersion of the PM, decreases relatively, and as a result, non-uniform deposition becomes easy to occur. Accordingly, in cases where the exhaust gas purification apparatus according to the present invention is further provided with a controller that estimates an amount of discharge of PM discharged from said internal combustion engine, during the time said regeneration processing is not carried out, the larger said estimated amount of discharge of PM, the more said controller may increase the above-mentioned predetermined threshold amount of change. According to this, the larger the amount of discharge of PM, the easier it become to judge that the specific non-uniform deposition has occurred, and hence, as a result, before the non-uniform deposition progresses to the degree to which the local excessive temperature rise is caused, it becomes possible to carry out the regeneration processing of the filter in a more reliable manner.

Moreover, in cases where the exhaust gas purification apparatus according to the present invention is further provided with an EGR device that recirculates a part of the exhaust gas flowing through said exhaust passage to intake air in said internal combustion engine, when said integrated period of time becomes equal to or more than said predetermined threshold period of time, during the time said regeneration processing is not carried out, said controller may decrease the amount of the exhaust gas recirculated by said EGR device, before carrying out said regeneration processing. Here, when the regeneration processing is carried out by the above-mentioned controller before the estimated amount of deposition becomes equal to or more than the predetermined threshold amount of deposition, the interval of execution of the regeneration processing is shortened, and as a result, the frequency of the execution of the regeneration processing becomes high, thereby giving rise to a fear that an increase in fuel consumption may be caused. According to this configuration, by decreasing the amount of the exhaust gas recirculated by the EGR device before the regeneration processing is carried out, the amount of PM itself discharged from the internal combustion engine can be decreased. This serves to delay the progress of the PM deposition, as a result of which it becomes possible to suppress an increase in the frequency of the execution of the regeneration processing, thereby suppressing the increase of fuel consumption.

Here, note that in the exhaust gas purification apparatus according to the present invention, said filter has a selective catalytic reduction catalyst supported on its substrate for selectively reducing nitrogen oxides in exhaust gas by using a reducing agent, and is further provided with a reducing agent addition valve that is arranged at the upstream side of said filter in said exhaust passage and adds the reducing agent or a precursor thereof to the exhaust gas flowing into the filter, and said deflector may be formed in such a manner as to deflect the exhaust gas flowing into said filter, whereby said reducing agent or the precursor thereof added from said addition unit is caused to diffuse within the exhaust gas. In the exhaust gas purification apparatus provided with such a configuration, the exhaust gas flowing into the filter is deflected more by the deflector, and hence, there is a tendency in which the non-uniform deposition of PM tends to occur. According to the present invention, even with such a configuration, it becomes possible to carry out the regeneration processing of the filter, before non-uniform deposition progresses to such a degree as to cause a local excessive temperature rise.

### Advantageous Effects of Invention

According to the present invention, in an exhaust gas purification apparatus for an internal combustion engine which is provided with a filter for trapping particulate matter and a deflector for deflecting exhaust gas flowing into the filter, in cases where there is a fear that non-uniform deposition of PM may occur due to the continuation of a state where the flow rate of the exhaust gas has not changed relatively, regeneration processing is carried out before an estimated amount of deposition of PM becomes equal to or more than a predetermined threshold amount of deposition. As a result of this, the regeneration processing of the filter can be carried out before the non-uniform deposition of PM progresses to an excessive extent, thus making it possible to suppress in advance a local excessive temperature rise of the filter resulting from the non-uniform deposition.

### BRIEF DESCRIPTION OF DRAWINGS

FIG. 1 is a view showing the schematic construction of an exhaust gas purification apparatus for an internal combustion engine according to an embodiment of the present invention.

FIG. 2A is a view showing a distribution state when PM has deposited in a uniform manner in a filter according to the embodiment.

FIG. 2B is a view showing a distribution state when PM has deposited in a non-uniform manner in a filter according to the embodiment.

FIG. 3A is a schematic diagram showing a distribution of deposition of PM in the filter according to the embodiment, wherein the relation between an amount of deposition of PM and a threshold amount of deposition is illustrated.

FIG. 3B is a schematic diagram showing a distribution of deposition of PM in the filter according to the embodiment, wherein there is illustrated a state in which a local excessive temperature rise has occurred.

FIG. 4 is a flow chart showing a control routine of regeneration processing according to the embodiment.

FIG. 5A is a schematic diagram showing a distribution of deposition of PM in the filter according to the embodiment, wherein the relation between an amount of deposition of PM corrected to be increased and the threshold amount of deposition is illustrated.

FIG. 5B is a schematic diagram showing a distribution of deposition of PM in the filter according to the embodiment, wherein there is illustrated a state in which a local excessive temperature rise is avoided.

FIG. 6 is a flow chart showing a control routine of regeneration processing according to a second embodiment.

FIG. 7 is a flow chart showing a control routine of regeneration processing according to a third embodiment.

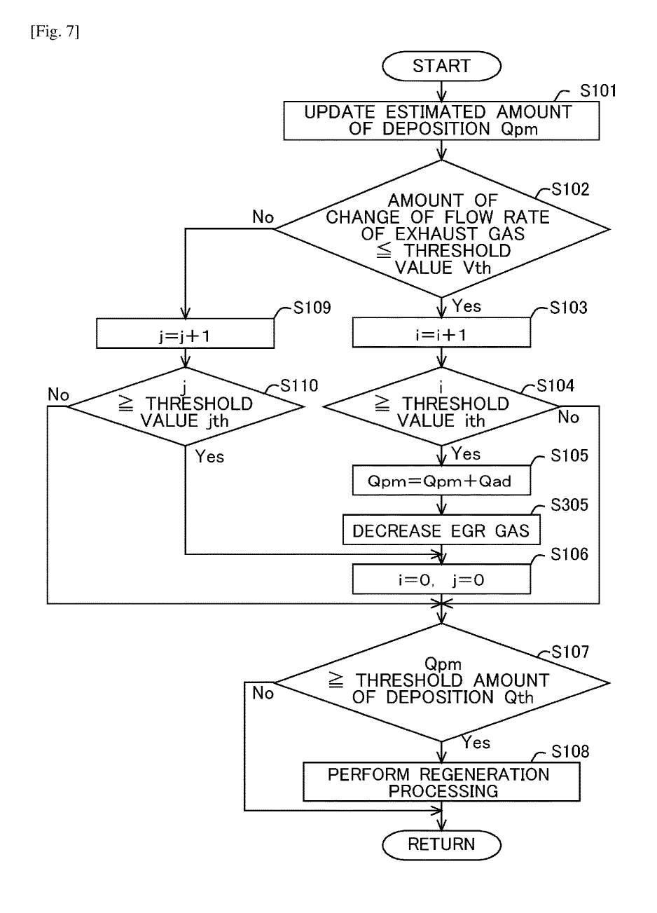

### DESCRIPTION OF EMBODIMENTS

Hereinafter, specific embodiments of the present invention will be described based on the attached drawings. However, the dimensions, materials, shapes, relative arrangements and so on of component parts described in the embodiments are not intended to limit the technical scope of the present invention to these alone in particular as long as there are no specific statements.

### First Embodiment

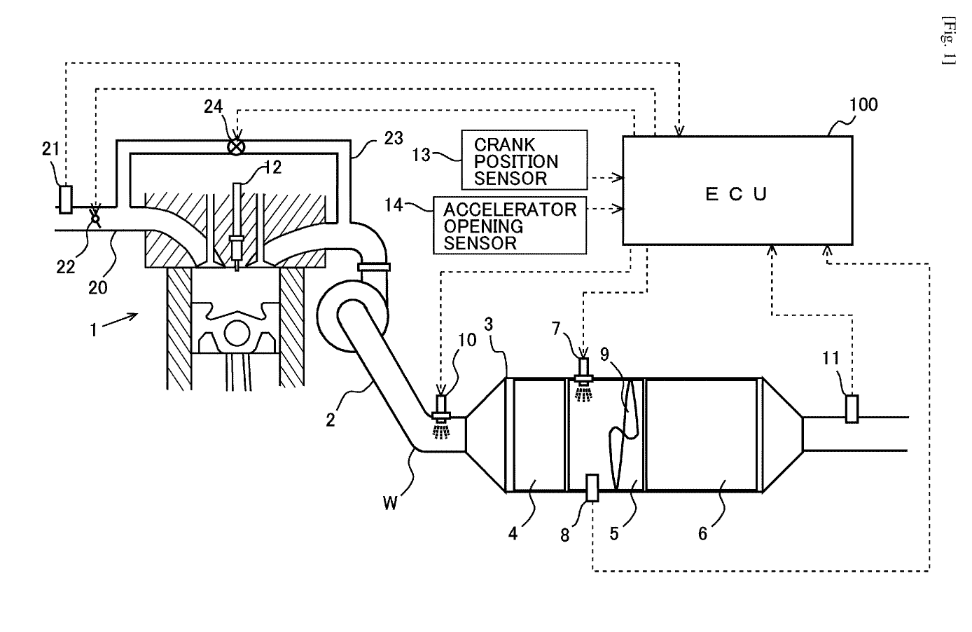

Reference will be made to an embodiment of the present invention by using drawings. FIG. 1 is a view showing the schematic construction of an exhaust gas purification apparatus for an internal combustion engine to which the present invention is applied. The internal combustion engine 1 shown in FIG. 1 is a diesel engine for an automotive vehicle having a plurality of cylinders. However, it is to be noted that an internal combustion engine to which the exhaust gas purification apparatus according to the present invention can be applied is not limited to diesel engines, but may be gasoline engines, or other kinds of internal combustion engines.

An exhaust passage 2 and an intake passage 20 are connected to the internal combustion engine 1. In the interior of a casing 3 arranged in the exhaust passage 2, there are arranged an oxidation catalyst 4, a mixer 5, and an SCRF 6 sequentially from an upstream side. The oxidation catalyst 4 serves to oxidize fuel, carbon monoxide, etc., in an exhaust gas flowing therein. The SCRF 6 is a wall flow type filter for trapping particulate matter in the exhaust gas, and has an NOx selective catalytic reduction catalyst (hereinafter referred to as an SCR catalyst) which is supported by its substrate and which serves to selectively reduce NOx in the exhaust gas with the use of ammonia as a reducing agent. In the mixer 5, there are arranged an urea water addition valve 7, a first NOx sensor 8 for detecting an amount of NOx in the exhaust gas flowing into the SCRF 6, and a dispersion plate 9. The urea water addition valve 7 adds urea water with urea as a precursor of ammonia dissolved therein to the exhaust gas flowing into the SCRF 6. The dispersion plate 9 is composed of a spirally shaped member, and serves to deflect the exhaust gas flowing into the SCRF 6, so that it is made to change to a spiral flow. With the exhaust gas being changed in this manner, the urea water added from the urea water addition valve 7 is dispersed in a suitable manner in the exhaust gas flowing into the SCRF 6. Here, the urea in the urea water is hydrolyzed in the SCRF 6 to generate ammonia. The SCRF 6 adsorbs the ammonia generated in this manner, and reduces NOx in the exhaust gas by means of a selective reduction reaction using the thus adsorbed ammonia as a reducing agent. Here, note that in this embodiment, the SCRF 6 and the urea water addition valve 7 correspond to a filter and a reducing agent addition valve, respectively, according to the present invention.

A fuel addition valve 10 is arranged in the exhaust passage 2 at the upstream side of the casing 3. This fuel addition valve 10 serves to add fuel to the exhaust gas flowing into the oxidation catalyst 4 at the time when the regeneration processing of the SCRF 6 (to be described later in detail) is carried out. In this embodiment, the fuel addition valve 10 corresponds to a fuel addition unit in the present invention. In addition, at the downstream side of the casing 3, there is arranged a second NOx sensor 11 for detecting an amount of NOx in the exhaust gas flowing out of the SCRF 6. Here, note that in the intake passage 20, there are arranged an air flow meter 21 for detecting an amount of intake air in the internal combustion engine 1 and a throttle valve 22 for adjusting this amount of intake air.

Then, in the internal combustion engine 1, there is arranged in combination therewith an ECU 100 which is an electronic control unit for controlling the internal combustion engine 1. The urea water addition valve 7, the fuel addition valve 10 and the throttle valve 22 are also electrically connected to the ECU 100, so that they are controlled by the ECU 100. In addition, the sensors such as the first NOx sensor 8, etc., are electrically connected to the ECU 100, so that the output signals of these sensors are inputted to the ECU 100. The ECU 100 controls the amount of the urea water to be added from the urea water addition valve 7 based on the detected value of the first NOx sensor 8. Moreover, a crank position sensor 13 for detecting the rotational position of a crankshaft of the internal combustion engine 1 and an accelerator opening sensor 14 for detecting the opening degree of an accelerator pedal which is provided on a vehicle with the internal combustion engine 1 mounted thereon are electrically connected to the ECU 10, so that the output signals of these sensors are inputted to the ECU 100. The ECU 100 grasps the operating state of the internal combustion engine 1 (the number of engine revolutions per unit time and the engine load) based on the output signals from the individual sensors, and carries out the control of an amount of injection fuel injected from a fuel injection valve 12 arranged in each combustion chamber of the internal combustion engine 1, etc. Here, note that a speed meter (not shown) for detecting the speed of the vehicle on which the internal combustion engine 1 is mounted, a water temperature sensor (not shown) for detecting the temperature of cooling water in the internal combustion engine 1, etc., are electrically connected to the ECU 100.

Here, note that in the exhaust passage 2, there may appropriately be provided a temperature sensor for detecting the temperature of the exhaust gas, a differential pressure sensor for detecting a differential pressure across the SCRF 6, an A/F sensor for detecting the air fuel ratio of the exhaust gas, and so on. In addition, the installation positions and the number of installation of the various kinds of sensors may be changed in an appropriate manner. Moreover, at the downstream side of the SCRF 6, there may be arranged an oxidation catalyst for oxidizing the ammonia flowing out of the SCRF 6.

In addition, an EGR passage 23 for recirculating a part of the exhaust gas discharged from the internal combustion engine 1 to the intake passage 20 is connected at its one end to the exhaust passage 2 at the upstream side of the fuel addition valve 10. The EGR passage 23 is connected at its other end to the intake passage 20 at the downstream said of the throttle valve 22. Moreover, an EGR valve 24 for adjusting the flow rate of the exhaust gas to be recirculated (EGR gas) is arranged in the EGR passage 23. The EGR valve 24 is electrically connected to the ECU 100, so that it is controlled by the ECU 100. By adjusting recirculating the amount of EGR gas to be recirculated, it becomes possible to control the combustion temperature of the internal combustion engine 1, etc., so that suppression of the amount of NOx discharged from the internal combustion engine 1, etc., can be carried out. Here, note that the EGR passage 23 and the EGR valve 24 together constitute an EGR device according to the present invention.

In the exhaust gas purification apparatus for an internal combustion engine 1 constructed as described above, the PM in the exhaust gas is removed by the SCRF 6. Here, the PM trapped by the SCRF 6 deposits gradually, but when the amount of deposition exceeds a certain amount, a problem may be caused to the operating state of the internal combustion engine 1 due to the increase of pressure loss in the SCRF 6. Accordingly, in this embodiment, an amount of deposition of the PM deposited in the entire SCRF 6 is estimated, and when the amount of deposition thus estimated (the estimated amount of deposition) becomes equal to or more than a predetermined threshold amount of deposition, regeneration processing for removing the deposited PM is carried out. The estimated amount of deposition is obtained, for example, by integrating the amount of PM to deposit in the SCRF 6 per unit time. As the amount of PM to deposit in the SCRF 6 per unit time, there may be used the amount of discharge of PM per unit time obtained from the number of revolutions per unit time of the internal combustion engine 1, the engine load, the amount of fuel injection, the amount of intake air, etc. In addition, the threshold amount of deposition is set in advance through experiments or the like as a value sufficiently lower than the amount of deposition of PM in the entire filter at the time when an excessive temperature rise may occur, so as to prevent the damage of the SCRF 6 due to an excessive rise in temperature during the execution of the regeneration processing.

When the regeneration processing is carried out, the ECU 100 starts the addition of fuel from the fuel addition valve 10. The fuel thus added is oxidized in the oxidation catalyst 4, so that the exhaust gas flowing into the SCRF 6 is heated by the heat of oxidation generated. By the exhaust gas thus heated, the temperature of the SCRF 6 is caused to go up to a temperature at which the deposited PM is oxidized. Here, note that the amount of fuel addition from the fuel addition valve 10 is controlled by the ECU 100, so that the temperature of the SCRF 6 is maintained at a predetermined filter regeneration temperature (e.g., 600-650 degrees C.) at which the oxidation of the PM is promoted, and at the same time, the damage by the excessive temperature rise does not occur. When the maintained state in which the temperature of the SCRF 6 is maintained at the filter regeneration temperature continues for a certain period of time, the PM deposited in the SCRF 6 is oxidized and removed, so that the filtering function of the SCRF 6 is restored.

However, in this embodiment, the exhaust gas flowing into the SCRF 6 is deflected by the dispersion plate 9, so that when the exhaust gas thus deflected flows into the SCRF 6, a deviation may occur in the distribution of flow speed. Here, note that the flow speed distribution of the deflected exhaust gas changes depending on the flow rate of the exhaust gas. Therefore, depending on the state of the flow rate of the exhaust gas, a deviated or non-uniform deposition of PM may occur in the SCRF 6. In the following, the deviated or non-uniform deposition of PM occurring in this manner will be described by the use of the drawings.

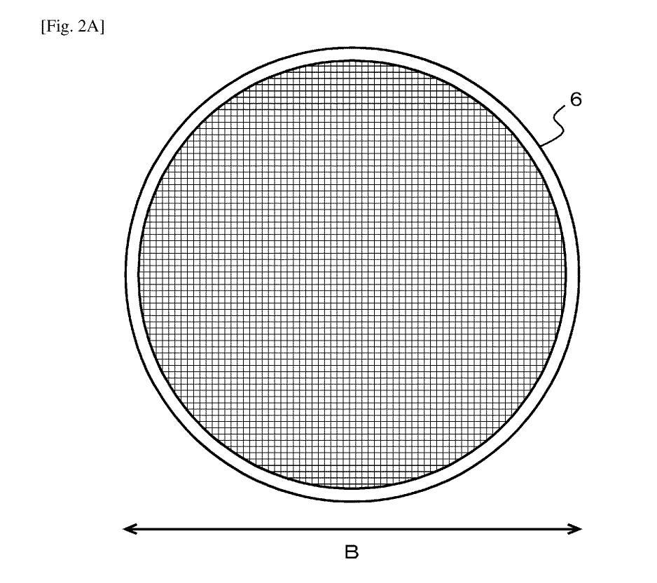

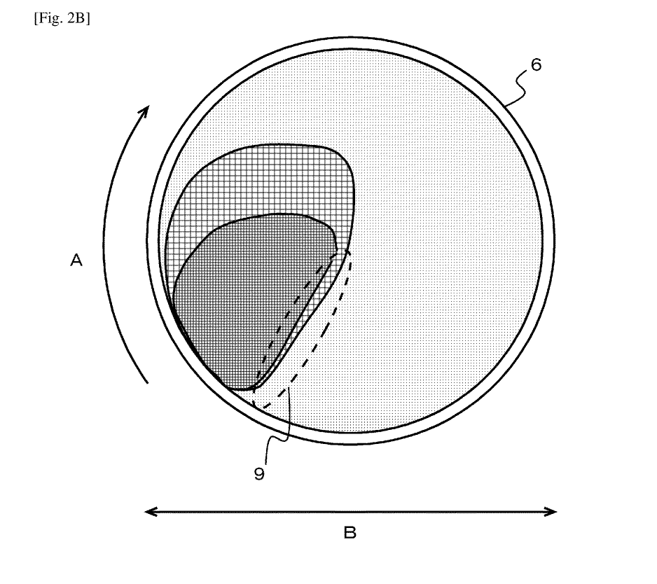

FIG. 2A and FIG. 2B are views schematically showing a distribution of deposition of the PM in the SCRF 6 by means of hatching, wherein it is illustrated that the thicker the hatching, the larger is the amount of deposition of the PM. Here, note that both figures are views when the SCRF 6 is seen from an upstream side. As described above, the distribution of the flow speed of the deflected exhaust gas changes depending on the flow rate of the exhaust gas, and hence, in cases where the flow rate of the exhaust gas flowing into the SCRF 6 (inflowing exhaust gas) varies while changing to a relatively large extent, the PM to be deposited is mostly dispersed within the SCRF 6. Accordingly, as shown in FIG. 2A, the distribution of deposition of the PM in this case becomes almost uniform.

On the other hand, in cases where a state in which the flow rate of the inflowing exhaust gas changes to a relatively small extent, i.e., a state in which the amount of change per unit time of the flow rate of the exhaust gas is relatively small, continues, there is maintained a state where the exhaust gas locally flows into the specific region of the SCRF 6. Specifically, the exhaust gas flowing into the SCRF 6 is changed by means of the spirally formed dispersion plate 9 into a spiral flow which progresses while rotating in the direction of arrow A, as shown in FIG. 2B. As a result of this, PM can be unevenly or non-uniformly deposited in the vicinity of a region which is in opposition to an opening portion of the dispersion plate 9 in the SCRF 6, as shown by a broken line in this figure. Here, note that the degree of the non-uniform deposition (the amount or density of the non-uniform deposition) thus occurred is dependent on the length of a period of time in which the local inflowing state of the deflected exhaust gas has been maintained. Here, in cases where the operation of the internal combustion engine 1 continues after the occurrence of the non-uniform deposition, the PM discharged due to the change in the operating state of the internal combustion engine 1, even if dispersed and deposited within the SCRF 6, may further be deposited in the region in which the non-uniform deposition has occurred. Accordingly, in cases where the degree of the non-uniform deposition has relatively progressed, if regeneration processing is carried out when the amount of deposition of the PM in the entire SCRF 6 has become equal to or more than the above-mentioned threshold amount of deposition due to further deposition of PM in that region, there will be a fear that a local excessive temperature rise may occur in that region. In the following, a local excessive temperature rise, which can occur in this manner, will be described.

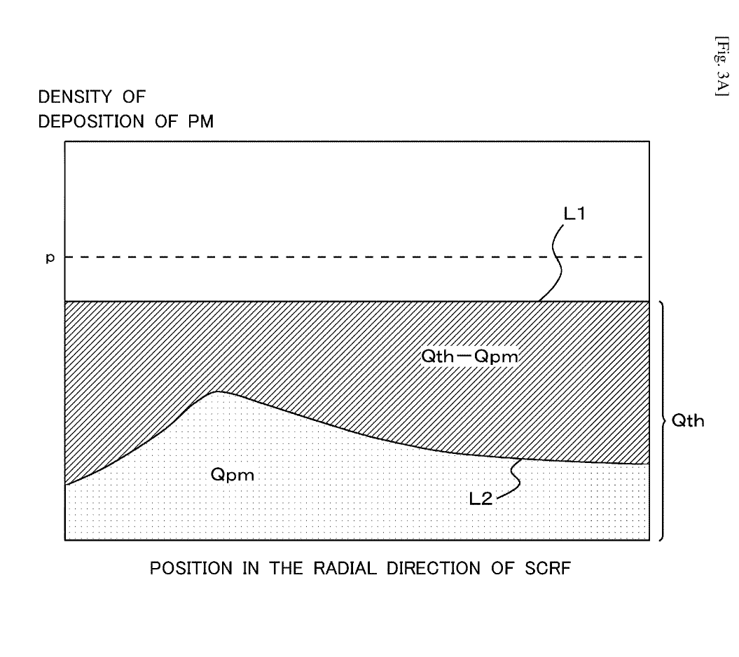

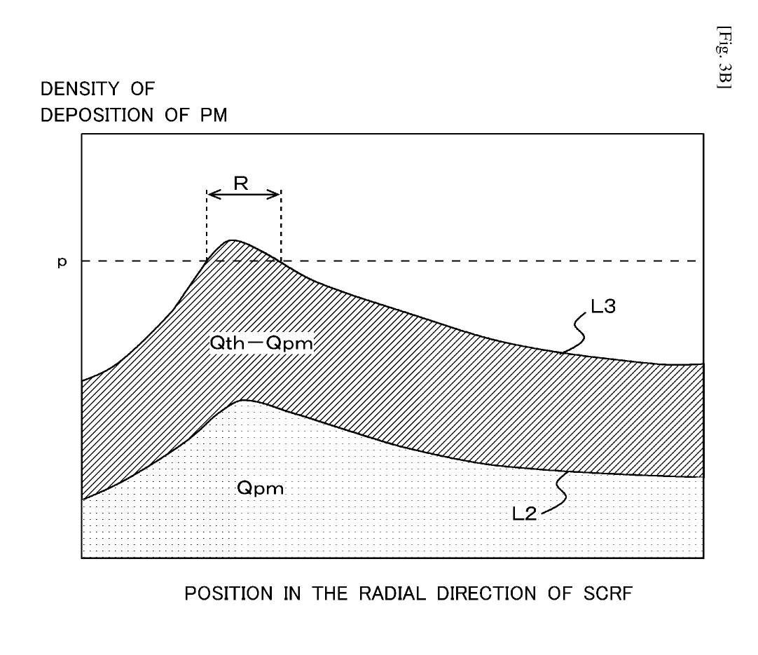

FIG. 3A and FIG. 3B are views each conceptually showing a distribution of deposition of the PM deposited in the SCRF 6. In both figures, the axis of abscissa indicates the position of an end face of the SCRF 6 in a radial direction (a direction of arrow B in FIG. 2A and FIG. 2B), and the axis of ordinate indicates the density of deposition of the PM at the position thereof in the radial direction. In other words, in both figures, each graph shows the distribution of deposition of the PM in the SCRF 6, and the area of a region surrounded by each graph shows the amount of the PM deposited on the SCRF 6. In addition, a threshold value p is a value of the density of deposition of the PM at which it is assumed that when the regeneration processing of the SCRF 6 is carried out, a local excessive temperature rise occurs.

When the PM discharged from the internal combustion engine 1 is being trapped by the SCRF 6, the density of deposition in each position or location will go up gradually. Then, when the area of a region surrounded by each graph showing a distribution of deposition becomes equal to or more than a threshold amount of deposition Qth, the regeneration processing of the SCRF 6 is carried out by the ECU 100. Here, graph L1 in FIG. 3A conceptually shows a distribution of deposition in the case where the PM in the threshold amount of deposition Qth has deposited in a uniformly distributed manner (here, note that the cross section of the SCRF 6 is circular, and so an actual distribution of deposition is different from this). In this case, the density of deposition of the PM in each location is less than the threshold value p, and hence, even if the regeneration processing is carried out, a local excessive temperature rise does not occur.

Here, graph L2 shows a distribution of deposition of PM when due to the continuation of the state where the flow rate of the inflowing exhaust gas changes to a relatively small extent, there has occurred an amount of non-uniform deposition of PM (specific non-uniform deposition) which is assumed to progress to such a degree as to cause a local excessive temperature rise, at the time when the estimated amount of deposition of the PM in the entire SCRF 6 will become equal to or more than the threshold amount of deposition Qth in the future. As described above, the area of a region below the graph L2 corresponds to the estimated amount of deposition Qpm of the PM which has deposited in the SCRF 6 at this point in time. Therefore, when PM in an amount of Qth−Qpm (hereinafter, also referred to as “additional PM”) further deposits in the SCRF 6 after this point in time, the regeneration processing will be carried out. Here, it is considered that if the density of deposition of the PM in each position of the SCRF 6 is less than the threshold value p at the time when the additional amount of PM has deposited, a local excessive temperature rise does not occur in the SCRF 6. However, in cases where the specific non-uniform deposition has occurred, even if the additional PM has mostly dispersed and deposited due to the operating state of the internal combustion engine 1 which varies while changing to a sufficient extent, a local excessive temperature rise may occur in a region R exceeding the threshold value p, at the time when the estimated amount of deposition of the entire SCRF 6 reaches Qth, as shown by graph L3 in FIG. 3B.

Accordingly, in this embodiment, in cases where a period of time for the amount of change per unit time of the flow rate of the exhaust gas of the inflowing exhaust gas to become equal to or less than a predetermined threshold amount of change has elapsed for a predetermined threshold period of time, during the time the estimated amount of deposition Qpm is less than the threshold amount of deposition Qth, it is judged that the specific non-uniform deposition has occurred, whereby early regeneration control is carried out which is the control for shortening the interval of execution of the regeneration processing by the ECU 100. Here, this threshold amount of change is an amount of change per unit time of the flow rate of the exhaust gas at the time when it is judged that the non-uniform deposition of PM as shown in FIG. 2B may occur in the specific region in the SCRF 6. This predetermined amount of change can be set in advance through experiments or the like, according to the degree of the deflection of the exhaust gas by the deflection plate 9. In addition, the predetermined threshold period of time can be set to a period of time taken for the specific non-uniform deposition as shown by the graph L2 to occur, due to the amount of change per unit time of the flow rate of the inflowing exhaust gas being equal to or less than the threshold amount of change. This threshold period of time can be set in advance through experiments or the like, in consideration of the heat resistance performance of the SCRF 6, the PM trapping ability thereof, etc. Here, note that because the deposited PM remains until regeneration processing is carried out, it is considered that even in cases where the state where the amount of change per unit time of the flow rate of the exhaust gas becomes equal to or less than the predetermined threshold amount of change continues intermittently, the non-uniform deposition of PM may progress. Accordingly, in the case where the integrated period of time obtained by integrating the period of time in which the amount of change is equal to or less than the predetermined threshold amount of change, becomes equal to or more than the predetermined threshold period of time, it is judged that the predetermined threshold period of time has elapsed, whereby early regeneration control is carried out.

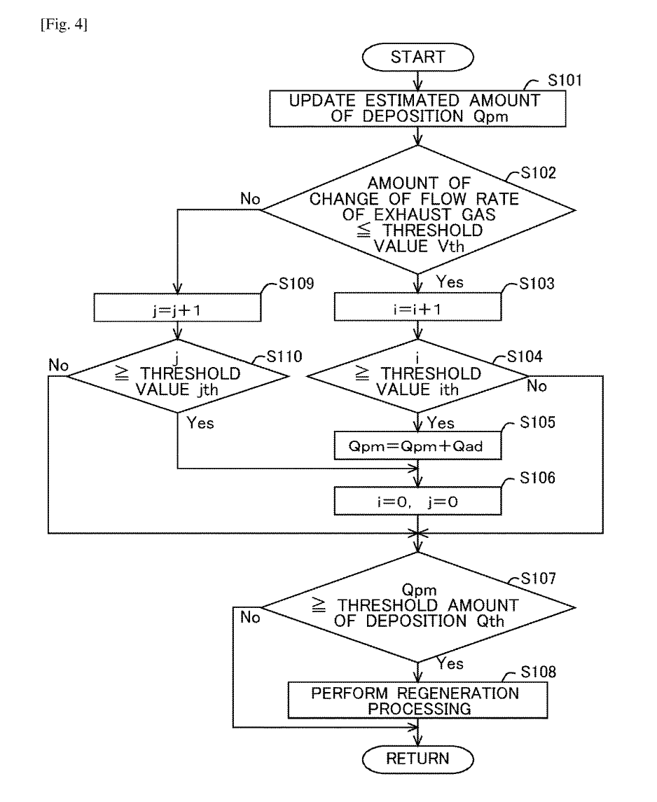

In the following, the early regeneration control will be explained by using drawings. FIG. 4 is a flow chart showing a control routine which is carried out by the ECU 100. This routine has been stored in the ECU 100, and is carried out at each interval of time TA in a periodic manner. Here, note that this interval of time TA is set as a sufficiently short period of time for calculating the amount of change per unit time of the flow rate of the exhaust gas with a high degree of accuracy.

First, in step S101, the ECU 100 updates the value of the estimated amount of deposition Qpm in order to obtain an amount of deposition of the PM deposited in the SCRF 6 at the time of carrying out this routine. Specifically, an amount of the PM deposited from the end time of the last routine to the start time of the current routine is added to the value of an estimated amount of deposition Qpm at the end time of the last routine. Here, note that the amount of addition of the PM is obtained from an amount of the PM deposited in the filter per unit time which is estimated from the number of revolutions per unit time of the internal combustion engine 1, the amount of fuel injection, etc.

Subsequently, in step S102, the ECU 100 determines whether the amount of change per unit time of the flow rate of the exhaust gas (the inflowing exhaust gas) deflected by the dispersion plate 9 is equal to or less than a threshold value Vth. This threshold value Vth is a value corresponding to the above-mentioned predetermined threshold amount of change, and is set in advance through experiments or the like. Here, note that the flow rate of the deflected exhaust gas can be replaced by the flow rate of the exhaust gas discharged from the internal combustion engine 1 (simply referred to as the flow rate of the exhaust gas). Accordingly, in this step, it is determined whether a value, which is obtained by dividing an absolute value of a difference between a flow rate of the exhaust gas at the time of the execution of the last routine and a flow rate of the exhaust gas at the time of the execution of the current routine by TA, is equal to or less than the threshold value Vth. Here, note that in this embodiment, a flow rate of the exhaust gas at the time of the execution of each routine is obtained based on the amount of intake air detected by the air flow meter 21.

In cases where an affirmative determination is made in step S102, the ECU 100 goes to step S103 and adds 1 to a counter i. This counter i is incremented each time an affirmative determination is made in a preceding step, and can be regarded as an index indicating the duration of a state where the amount of change per unit time of the flow rate of the exhaust gas is equal to or less than the threshold value Vth (hereinafter, also referred to as “a low change amount state of the flow rate of the exhaust gas”).

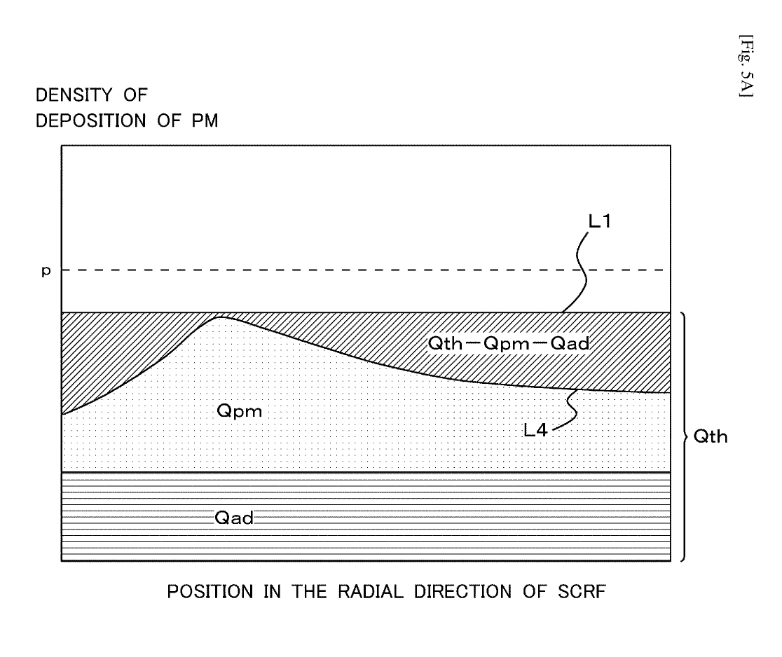

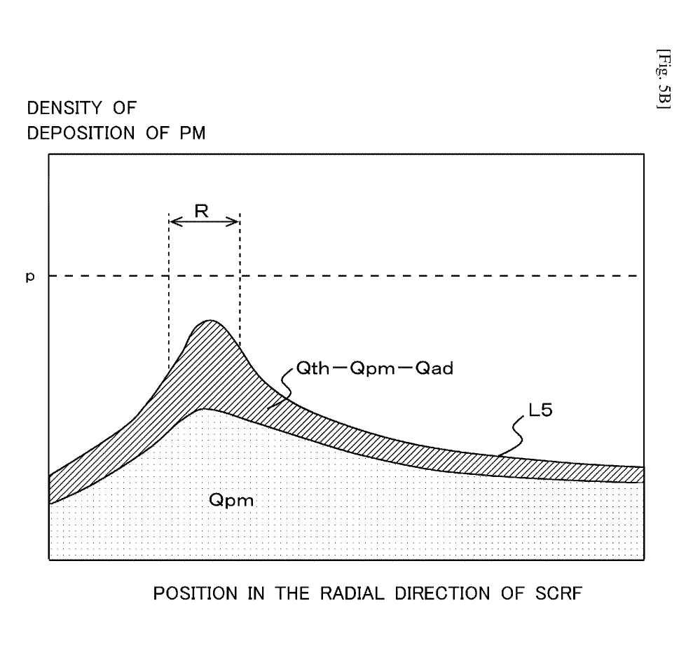

In step S104, the ECU 100 determines whether the counter i is equal to or more than a threshold value ith. Here, this threshold value ith is a value which is obtained by dividing the above-mentioned predetermined threshold period of time by the period of execution TA of this routine. In other words, when the counter i reaches the threshold value ith, it is judged that the predetermined threshold period of time has elapsed. In cases where an affirmative determination is made in this step, this means that the specific non-uniform deposition has occurred in the SCRF 6, so the ECU 100 goes to step S105, and adds an amount of correction Qad to the estimated amount of deposition Qpm updated in step S101. In other words, in step S105, an increase correction of the estimated amount of deposition Qpm is carried out. Here, reference will be made to the effect when the amount of correction Qad is added to the estimated amount of deposition Qpm in this manner, by using FIG. 5A and FIG. 5B. Both figures, similar to FIG. 3A and FIG. 3B, are views each conceptually showing a distribution of deposition of the PM deposited in the SCRF 6. As shown by graph L4 in FIG. 5A, when the amount of correction Qad is added to the estimated amount of deposition Qpm, it can be grasped that the distribution of deposition of the PM has been inflated or raised virtually. In this embodiment, when an increasingly corrected estimated amount of deposition (Qpm+Qad) becomes equal to or more than the threshold amount of deposition Qth, the regeneration processing is carried out, as will be described later. In other word, when PM in an amount of Qth−Qpm−Qad (hereinafter, also referred to as “post correction additional PM”), which is the area of a region surrounded by the graph L1 and the graph L4, further has deposited, the regeneration processing is carried out. Here, the amount of the post correction additional PM is less by Qad than the amount of the additional PM which has been explained by using FIG. 3A. Here, in cases where the amount of correction Qad is set to be large to a sufficient extent, even if the post correction additional PM has deposited intensively in the vicinity of the region R where the non-uniform deposition progresses, as shown by graph L5 in FIG. 5B, the density of deposition of the PM in each position becomes less than the threshold value p. Therefore, with the increase correction of the estimated amount of deposition Qpm being carried out in this manner, it becomes possible to start the regeneration processing of the filter, before the PM deposits in the region R to an excessive extent. As a result, at the time when the regeneration processing will be carried out in the future, it becomes possible to suppress in advance the occurrence of a local excessive temperature rise resulting from the non-uniform deposition of PM.

When the increase correction of the estimated amount of deposition Qpm is carried out in this manner, then in step S106, the ECU 100 resets the counter i and a counter j to be described later to zero. Then, in step S107, the ECU 100 determines whether the increasingly corrected estimated amount of deposition Qpm is equal to or more than the threshold amount of deposition Qth. In cases where an affirmative determination is made in this step S107, then in step S108, the ECU 100 carries out the regeneration processing of the SCRF 6. In other words, when the increasingly corrected estimated amount of deposition Qpm becomes equal to or more than the threshold amount of deposition Qth, the ECU 100 carries out the regeneration processing of the SCRF 6. With this, the regeneration processing is carried out before the estimated amount of deposition Qpm actually becomes equal to or more than the threshold amount of deposition Qth, so that it becomes possible to carry out the regeneration processing, before the non-uniform deposition progresses to such a degree as to cause a local excessive temperature rise.

Here, note that in cases where a negative determination is made in step S107, the current routine is ended, but when the estimated amount of deposition Qpm is updated in step S101 of a routine to be carried out in and after the next time, the estimated amount of deposition Qpm is updated based on the estimated amount of deposition Qpm to which the amount of correction Qad has been added in step S105 of the current routine. With this, in step S107 of a routine to be carried out in the future, it is determined whether an already increasingly corrected estimated amount of deposition Qpm is equal to or more than the threshold amount of deposition Qth. Therefore, in a future routine, too, when the increasingly corrected estimated amount of deposition Qpm becomes equal to or more than the threshold amount of deposition Qth, the regeneration processing is carried out. As a result, the regeneration processing is carried out before the estimated amount of deposition Qpm actually becomes equal to or more than the threshold amount of deposition Qth, so it becomes possible to carry out the regeneration processing before the non-uniform deposition progresses to such a degree that a local excessive temperature rise occurs.

Here, note that in cases where a negative determination is made in step S104, the ECU 100 judges that a period of time for the flow rate of the exhaust gas to become the low change amount state has not elapsed by the above-mentioned threshold period of time, and goes to step S107, without carrying out the increase correction of the estimated amount of deposition Qpm. Then, in step S107, the ECU 100 determines whether the estimated amount of deposition Qpm is equal to or more than the threshold amount of deposition Qth, and when an affirmative determination is made, the ECU 100 carries out the regeneration processing in step S108.

On the other hand, in cases where a negative determination is made in step S102, this means that the flow rate of the exhaust gas is not in the low change amount state. Accordingly, the ECU 100 goes to step S109, and adds 1 to the counter j. This counter j can be regarded as an index indicating the duration of a state where the amount of change per unit time of the flow rate of the exhaust gas is large to a sufficient extent (high change amount state). Here, it is considered that in cases where the exhaust gas is in the high change amount state, the PM to be deposited is dispersed to a sufficient extent within the SCRF 6.

Then, in step S110, the ECU 100 determines whether the counter j is equal to or more than a threshold value jth. Here, the period of time meant by this threshold value jth can be grasped as a period of time taken to form a distribution of deposition of PM which is judged that, as a result of the fact that PM has deposited while being dispersed by the exhaust gas becoming the high change amount state, a local excessive temperature rise can not occur even if the regeneration processing is carried out at the time when the estimated amount of deposition Qpm becomes equal to or more than the threshold amount of deposition Qth in the future. In other words, in cases where an affirmative determination is made in this step S110, this means that, even if the deposition of PM will progress hereafter, a region, in which the density of the deposition of the PM becomes equal to or more than the above-mentioned threshold value p, can not occur in the SCRF 6, before the estimated amount of deposition Qpm becomes equal to or more than the threshold amount of deposition Qth. Therefore, in this case, it is not necessary to perform the increase correction of the estimated amount of deposition Qpm for the purpose of carrying out the regeneration processing, before the estimated amount of deposition Qpm becomes equal to or more than the threshold amount of deposition Qth, and hence, in step S106, the ECU 100 resets the counters i and j to zero, and thereafter, goes to step S107. In cases where an affirmative determination is made in step S107, then in step S108, the ECU 100 carries out the regeneration processing.

Here, note that, as mentioned above, the deposited PM remains or continues to exist in the SCRF 6 until the regeneration processing is carried out. Accordingly, even in cases where the low change amount state continues intermittently, i.e., even in cases where an affirmative determination is not made continuously in step S102, the counter i may be incremented in step S103. In addition, with respect to the counter J, the same is also applied.

From the above, in the above-mentioned routine, when the specific non-uniform deposition of PM occurs, the regeneration processing is carried out before the estimated amount of deposition Qpm actually becomes equal to or more than the threshold amount of deposition Qth. In other words, according to the above-mentioned routine, in cases where there is a concern that a local excessive temperature rise resulting from the non-uniform deposition may occur, the regeneration processing can be started at an earlier stage, in comparison with the case where there is no such concern, and hence, the interval of execution of the regeneration processing may be shortened. As a result of this, even in cases where a certain amount of non-uniform deposition has occurred, it becomes possible to carry out the regeneration processing of the filter so that a local excessive temperature rise resulting from the non-uniform deposition of PM does not occur.

### Second Embodiment

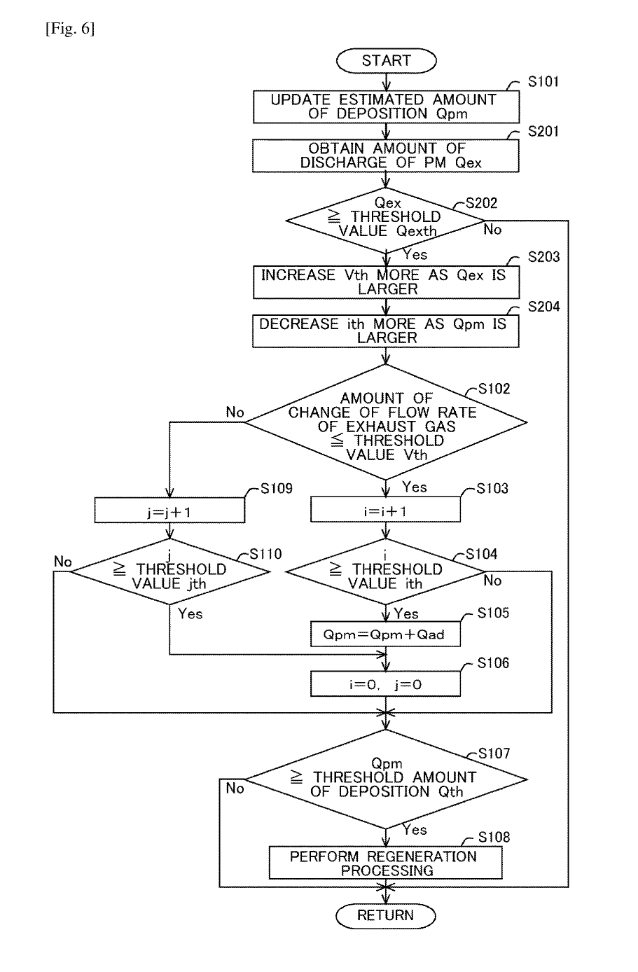

Next, a second embodiment of the present invention will be described as another example. The amount of discharge of PM discharged from the internal combustion engine 1 may change depending on the operating state of the internal combustion engine 1, but it is considered that in cases where the amount of discharge of PM is relatively large, the non-uniform deposition of PM in the SCRF 6 progresses at an earlier stage. Accordingly, in this second embodiment, in cases where the amount of discharge of PM is large, the above-mentioned threshold values ith and Vth are corrected according to the amount of discharge of the PM discharged from the internal combustion engine 1, in order that the regeneration processing of the SCRF 6 is carried out in a more reliable manner, before the non-uniform deposition progresses to such a degree as to cause a local excessive temperature rise. Hereinafter, the execution procedure of the early regenerative control in this embodiment will be described by the use of FIG. 6. This routine has been stored in the ECU 100, and is carried out at each interval of time TA in a periodic manner. Here, note that this routine is different from the flow shown in FIG. 4 in the point that steps S201 through S204 are carried out between the steps S101 and S102. Accordingly, for those steps which are common with the flow shown in FIG. 4, the explanation thereof is omitted. In addition, the configuration of an exhaust gas purification apparatus for the internal combustion engine 1 in this second embodiment is the same as that of the above-mentioned first embodiment, so the explanation thereof is also omitted.

When the step S101 is carried out, then in step S201, the ECU 100 estimates an amount of discharge Qex which is an amount of discharge of the PM discharged from the internal combustion engine 1 at the time of the execution of this routine. This amount of discharge is estimated based on the number of revolutions per unit time of the internal combustion engine 1, the amount of fuel injection, etc. Then, the ECU 100 goes to step S202, and determines whether the amount of discharge Qex thus obtained is equal to or more than a predetermined threshold value Qexth. The threshold value Qexth is a threshold value set in order to determine whether PM in such an amount as to deposit in the SCRF 6 has been discharged from the internal combustion engine 1. In cases where a negative determination is made in this step, this means that an amount of PM to such an extent as to deposit in the SCRF 6 has not been discharged, and it is also not necessary to take into consideration the non-uniform deposition of PM, as a result of which the ECU 10 immediately ends the execution of this routine. On the other hand, in cases where an affirmative determination is made in this step, the ECU 100 goes to step S203, where the larger the amount of discharge Qex, the more the threshold value Vth is made to increase. With this, even in cases where the amount of change per unit time of the flow rate of the exhaust gas is much larger, an affirmative determination will be made in step S102, as a result of which the counter i can become equal to or more than the threshold value ith at an earlier stage. According to this, when the non-uniform deposition of PM is easier to occur due to the amount of discharge Qex being relatively large, it becomes possible to carry out the regeneration processing of the filter in a more reliable manner, before the non-uniform deposition progresses to such a degree as to cause a local excessive temperature rise.

Subsequently, in step S204, the larger the estimated amount of deposition Qpm, the more the ECU 100 decreases the threshold value ith. Here, in cases where the estimated amount of deposition Qpm, which is the estimated amount of deposition in the entire SCRF 6, is relatively large, it is considered that the amount of discharge of the PM having been discharged from the internal combustion engine 1 at the time of the execution of the routine in the past is large, and hence, the probability that the non-uniform deposition of PM progresses to a more extent is high. Accordingly, by decreasing the threshold value ith in accordance with the increasing estimated amount of deposition Qpm, it becomes easier for an affirmative determination to be made in step S104, so that it can be judged that the specific non-uniform deposition has occurred at an earlier period of time. Therefore, before the non-uniform deposition progresses to such a degree as to cause a local excessive temperature rise, it becomes possible to carry out the regeneration processing of the SCRF 6 in a more reliable manner.

Thus, according to this embodiment, in cases where the probability that the non-uniform deposition progresses to a more extent is high, it becomes possible to carry out the regeneration processing of the SCRF 6 in a more reliable manner, before the non-uniform deposition progresses to such a degree as to cause a local excessive temperature rise, as a result of which it becomes possible to suppress the occurrence of the local excessive temperature rise resulting from the non-uniform deposition of PM in a more reliable manner.

### Third Embodiment

Next, a third embodiment of the present invention will be described as another example. In the early regeneration control in the above-mentioned embodiments, when the period of time for the flow rate of the exhaust gas to become the low change amount state has elapsed for the predetermined threshold period of time, the interval of execution of the regeneration processing of the SCRF 6 is shortened, thereby suppressing the local excessive temperature rise resulting from the non-uniform deposition of PM. However, in this case, the frequency of the execution of the regeneration processing can become high, and as a result, there is a fear of causing an increase in the fuel consumption. Accordingly, in the early regeneration control according to this third embodiment, the amount of EGR gas to be recirculated to the intake passage 20 through the EGR passage 23 is decreased by the ECU 100, before the regeneration processing of the SCRF 6 is carried out. Hereinafter, the execution procedure of the early regenerative control in this third embodiment will be described by the use of FIG. 9. This procedure or routine has been stored in the ECU 100, and is carried out at each interval of time TA in a periodic manner. Here, note that this routine is different from the flow shown in FIG. 4 in the point that step S305 is carried out after the step S105. Accordingly, for those steps which are common with the flow shown in FIG. 4, the explanation thereof is omitted. In addition, the configuration of an exhaust gas purification apparatus for the internal combustion engine 1 in this third embodiment is the same as that of the above-mentioned first embodiment, so the explanation thereof is also omitted.

When the step S105 is carried out, then in step S305, the ECU 100 decreases the amount of EGR gas by adjusting the degree of opening of the EGR valve 24. With this, the combustion temperature in the internal combustion engine 1 drops, so the amount of the PM discharged from the internal combustion engine 1 itself decreases. Accordingly, even after the interval of execution of the regeneration processing has been shortened by carrying out the increase correction of the estimated amount of deposition Qpm, it is possible to delay the progress of the PM deposition. In this manner, by decreasing the amount of EGR gas to be recirculated through the EGR passage 23, before the execution of the regeneration processing, an increase in the frequency of the execution of the regeneration processing can be suppressed, while suppressing the occurrence of the local excessive temperature rise resulting from the non-uniform deposition, thereby making it possible to suppress the increase of fuel consumption.

(Modification)

In the early regeneration control in the above-mentioned embodiments, when the period of time for the flow rate of the exhaust gas to become the low change amount state has elapsed for the predetermined threshold period of time, the interval of execution of the regeneration processing of the SCRF 6 is shortened, by carrying out the increase correction of the estimated amount of deposition Qpm. On the other hand, in order to shorten the interval of execution of the regeneration processing, the decrease correction of the threshold amount of deposition Qth may be corrected to decrease, instead of carrying out the increase correction of the estimated amount of deposition Qpm. In other words, in this modification, in cases where it is judged that a specific non-uniform deposition has occurred, a predetermined amount of correction is subtracted from the threshold amount of deposition Qth, and thereafter, when the estimated amount of deposition Qpm becomes equal to or more than the threshold amount of deposition thus subjected to the subtraction correction, the regeneration processing is started. As a result of this, similar to the above-mentioned embodiments, when the specific non-uniform deposition of PM has occurred, the regeneration processing is carried out before the estimated amount of deposition Qpm actually becomes equal to or more than the threshold amount of deposition Qth, and hence, it becomes possible to carry out the regeneration processing of the filter so that a local excessive temperature rise resulting from the non-uniform deposition of PM does not occur.

In addition, in the above-mentioned embodiments, it is presupposed that the exhaust gas is deflected by the dispersion plate 9, but the exhaust gas flowing into the SCRF 6 can be deflected by other factors. For example, in cases where the exhaust gas deflected by a curved portion W formed in the exhaust passage 2 at the upstream side of the SCRF 6, as shown in FIG. 1, flows into the SCRF 6, too, the non-uniform deposition of PM may occur. Accordingly, if the above-mentioned threshold values Vth, ith, jth, and the amount of correction Qad are set in an appropriate manner according to the curvature of the curved portion W, etc., by performing the same processing as in the above-mentioned flows, it becomes possible to carry out the regeneration processing of the filter in a more reliable manner before the non-uniform deposition progresses to such a degree as to cause a local excessive temperature rise, even in the case where a certain amount of non-uniform deposition has occurred.

Moreover, in the above-mentioned embodiments, the flow rate of the exhaust gas at the time of the execution of the control routine is obtained based on the amount of intake air in the internal combustion engine 1 detected by the air flow meter 21, but this flow rate of the exhaust gas may instead be obtained by other methods. For example, this flow rate of the exhaust gas can be obtained based on a value of the vehicle speed of the vehicle at the time of the execution of the control routine, which has been corrected according to the degree of opening of the throttle valve 22, and/or the degree of opening of the EGR valve 24. In this case, the correction is carried in such a manner that the smaller the degree of opening of the throttle valve 22, and the larger the degree of opening of the EGR valve 24, the smaller the flow rate of the exhaust gas flowing into the SCRF 6 becomes. By using such a method, in the above-mentioned embodiments, there can be adopted a configuration in which the early regeneration control is carried out when a period of time in which the vehicle is traveling at a vehicle speed at which the flow rate of the exhaust gas is in the low change amount state has elapsed for a predetermined threshold period of time, instead of using a period of time in which the flow rate of the exhaust gas is in the low change amount state. In this case, the above-mentioned early regeneration control can be carried out, by setting a threshold value for the amount of change per unit time of the vehicle speed in an appropriate manner, instead of setting the threshold value Vth for the amount of change per unit time of the flow rate of the exhaust gas.

### REFERENCE SIGNS LIST

1 internal combustion engine
2 exhaust passage
6 SCRF
9 dispersion plate
10 fuel addition valve

1. An exhaust gas purification apparatus for an internal combustion engine comprising:
a filter that is arranged in an exhaust passage of the internal combustion engine for trapping particulate matter in exhaust gas;
a deflector that is arranged at the upstream side of said filter in said exhaust passage and configured to deflect exhaust gas flowing into said filter; and
a controller configured to estimate an amount of deposition of particulate matter deposited in said filter, and carry out regeneration processing to oxidize the particulate matter deposited in said filter when the estimated amount of deposition estimated by said controller is equal to or more than a predetermined threshold amount of deposition;
wherein when an integrated period of time, which is obtained by integrating a period of time in which an amount of change per unit time of a flow rate of the exhaust gas deflected by said deflector is equal to or less than a predetermined threshold amount of change, becomes equal to or more than a predetermined threshold period of time, during the time said regeneration processing is not carried out, said controller further configured to carry out said regeneration processing before said estimated amount of deposition becomes equal to or more than said predetermined threshold amount of deposition.

2. The exhaust gas purification apparatus for an internal combustion engine as set forth in claim 1, wherein
during the time said regeneration processing is not carried out, said controller further configured to increase the estimated amount of deposition estimated by said controller, when said integrated period of time becomes equal to or more than said predetermined threshold period of time, and thereafter, carry out said regeneration processing when the increased estimated amount of deposition becomes equal to or more than said threshold amount of deposition.

3. The exhaust gas purification apparatus for an internal combustion engine as set forth in claim 1, wherein
during the time said regeneration processing is not carried out, the more the estimated amount of deposition estimated by said controller, the more said controller further configured to decrease said threshold period of time.

4. The exhaust gas purification apparatus for an internal combustion engine as set forth in claim 1, wherein
said controller further configured to estimate an amount of discharge of particulate matter discharged from said internal combustion engine; and
during the time said regeneration processing is not carried out, the larger said estimated amount of discharge of particulate matter, the more said controller further configured to increase said predetermined threshold amount of change.

5. The exhaust gas purification apparatus for an internal combustion engine as set forth in claim 1, further comprising:
an EGR device configured to recirculate a part of exhaust gas flowing through said exhaust passage to intake air in said internal combustion engine;
wherein when said integrated period of time becomes equal to or more than said predetermined threshold period of time, during the time said regeneration processing is not carried out, said controller further configured to decrease the amount of the exhaust gas recirculated by said EGR device, before carrying out said regeneration processing.

6. The exhaust gas purification apparatus for an internal combustion engine as set forth in claim 1, further comprising:
a reducing agent addition valve that is arranged at the upstream side of said filter in said exhaust passage and configure to add the reducing agent or a precursor thereof into the exhaust gas flowing into the filter;
wherein said filter has a selective catalytic reduction catalyst supported on its substrate for selectively reducing nitrogen oxides in exhaust gas by using a reducing agent; and
said deflector is formed in such a manner as to deflect the exhaust gas flowing into said filter, whereby said reducing agent or the precursor thereof added from said addition unit is caused to diffuse within the exhaust gas.
